(19) United States
(12) Patent Application Publication
(10) Pub. No.: US 2025/0258926 A1
(43) Pub. Date: Aug. 14, 2025

(54) SECURITY EVALUATION DEVICE, SECURE SYSTEM AUTOMATIC DESIGN DEVICE, SECURITY, AND EVALUATION METHOD

(71) Applicant: NEC Corporation, Tokyo (JP)

(72) Inventor: Ryosuke HOTCHI, Tokyo (JP)

(73) Assignee: NEC Corporation, Tokyo (JP)

(21) Appl. No.: 19/045,752

(22) Filed: Feb. 5, 2025

(30) Foreign Application Priority Data
Feb. 13, 2024 (JP) 2024-019362

(51) Int. Cl. G06F 21/57; G06F 21/55

(52) U.S. Cl. CPC G06F 21/577; G06F 21/554

(57) ABSTRACT

A security evaluation device calculates a threat evaluation value for each of all threats present in a system configuration plan based on an evaluation value of a probability of a threat occurring, an evaluation value of an execution frequency of the threat, and an evaluation value of an effectiveness of a mitigation measure for the threat that is possessed by a countermeasure against the threat, which are defined for each type of security threat, and calculates a quantitative security evaluation value for the system configuration plan based on the threat evaluation values calculated for each of all of the threats.

### CROSS-REFERENCE TO RELATED APPLICATIONS

This application is based upon and claims the benefit of priority from Japanese patent application No. 2024-019362, filed on Feb. 13, 2024, the disclosure of which is incorporated herein in its entirety by reference.

### TECHNICAL FIELD

The present disclosure relates to a security evaluation device, a secure system automatic design device, and a security evaluation method.

### BACKGROUND ART

Ryosuke Hotchi, Takayuki Kuroda, “Automatic design of secure systems based on the search for methods to realize cyber attacks”, Institute of Electronics, Information and Communication Engineers, Technical Committee on Network Virtualization (NV), Nov. 24, 2022, [Retrieved Jan. 29, 2024], Internet <https://www.ieice.org/cs/nv/wp-content/uploads/2022/11/NV2022-11-Hotchi-NEC.pdf> (Non-Patent Document 1) discloses a technology for automatically designing a secure system configuration (hereinafter referred to as a “secure system automatic design technology”). This technology first generates multiple system configuration plans, evaluates the security of each system configuration plan, and extracts and outputs system configuration plans that are evaluated as secure. The generated system configuration plan is a concrete system configuration, and security evaluation is performed based on the concrete system configuration.

The secure system automatic design technology described in Non-Patent Document 1 uses the concept of “threat” to express attacks that the system designer of the system automatic design wants to prevent from occurring and the means by which an attacker can execute the attack. This technology uses a security assessment method in which, in the system configuration plan generated during automatic system design, the presence of an “attack path,” a chain of threat routes that indicate the steps an attacker could take to execute the attack that the system designer wants to prevent, is comprehensively searched for, and if an attack path is found, the system configuration plan is judged to be unsecure. In the technology described in Non-Patent Document 1, a system configuration plan is found to be unsecure only in a case where an attack path is established. Therefore, in order for security assessment to be effective, it is necessary to continue to refine the system configuration plan until an attack path is established. This results in an inefficient search that takes a long time before the information that is unsecure is discovered. Furthermore, the secure determination method described in Non-Patent Document 1 only allows a qualitative evaluation of whether a system is “unsecure” or “not unsecure” based on whether or not a valid attack path exists. Furthermore, although International Publication No. 2023/042257 (Patent Document 1) describes evaluating the security level of an automatically designed system configuration plan, this evaluation is merely qualitative.

### SUMMARY

One of the example objects of the present disclosure is to provide a method for quantitatively evaluating whether a system being designed is secure or unsecure during automatic design of a secure system.

According to one example aspect of the present disclosure, a security evaluation device is provided with a means for calculating a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are defined for each type of security threat; and a means for calculating a quantitative security evaluation value for the system configuration plan based on the threat evaluation values calculated for each of all of the threats.

According to one example aspect of the present disclosure, a secure system automatic design device is provided with a means for receiving design requirements for the system; a means for generating a plurality of system configuration plans that satisfy the design requirements; the security evaluation device that calculates the evaluation value for each of the generated system configuration plans; and a means for determining whether each of the generated system configuration plans is secure or unsecure based on the security evaluation value.

According to one example aspect of the present disclosure, a security evaluation method calculates a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are defined for each type of security threat; and calculates a quantitative security evaluation value for the system configuration plan based on the threat evaluation values calculated for each of all of the threats, the security evaluation being executed by a computer.

According to one example aspect of the present disclosure, a secure system automatic design method receives system design requirements; generates a plurality of system configuration plans that satisfy the design requirements; calculates the evaluation value for each of the generated system configuration plans by the security evaluation method; and determines whether each of the generated system configuration plans is secure or unsecure based on the security evaluation value, the secure system automatic design method being executed by a computer.

According to one example aspect of the present disclosure, a program causes a computer to execute the above-described security evaluation method.

According to one example aspect of the present disclosure, a program causes a computer to execute the above-described secure system automatic design method.

According to the present disclosure, in the automatic design of a computer system, it is possible to quantitatively evaluate whether a system configuration that embodies system requirements input by a user is secure or unsecure.

### BRIEF DESCRIPTION OF THE DRAWINGS

FIG. 1 is a first schematic block diagram showing an example of a functional configuration of a secure system automatic design device.

FIG. 2 is a first diagram showing a legend of a method for expressing a system configuration plan.

FIG. 3 is a first diagram showing an example of a security model.

FIG. 4 is a first diagram showing an example of requirement data.

FIG. 5A is a first diagram showing an example of a graphical representation of a system configuration plan input to a security evaluation value derivation portion.

FIG. 5B is a first diagram showing an example of a text expression of a system configuration plan input to a security evaluation value derivation portion.

FIG. 6 is a first diagram showing an example of a system configuration plan immediately after a threat evaluation value is derived.

FIG. 7 is a first diagram showing an example of a system configuration plan immediately after a security evaluation value is derived.

FIG. 8 is a first flowchart showing an example of an operation of a secure system automatic design device.

FIG. 9 is a second schematic block diagram showing a functional configuration of a secure system automatic design device.

FIG. 10 is a second diagram showing a legend of a method for expressing a system configuration plan.

FIG. 11 is a second diagram showing an example of a security model.

FIG. 12 is a second diagram showing an example of requirement data.

FIG. 13A is a second diagram showing an example of a graphical representation of a system configuration plan input to the security evaluation value derivation portion.

FIG. 13B is a second diagram showing an example of a text expression of a system configuration plan input to the security evaluation value derivation portion.

FIG. 14 is a second diagram showing an example of a system configuration plan immediately after a threat evaluation value is derived.

FIG. 15 is a second diagram showing an example of a system configuration plan immediately after a security evaluation value is derived.

FIG. 16 is a second diagram showing an example of a system configuration plan immediately after an attack path evaluation value is derived.

FIG. 17 is a second flowchart showing an example of an operation of a secure system automatic design device.

FIG. 18 is a schematic block diagram showing an example of a functional configuration of a security evaluation device.

FIG. 19 is a flowchart showing an example of the operation of the security evaluation device.

FIG. 20 illustrates an example of a hardware configuration of a secure system automatic design device and the like.

### EXAMPLE EMBODIMENT

Hereinbelow, a secure system automatic design device according to each example embodiment of the present disclosure will be described with reference to the drawings. In the drawings used in the following description, the configuration of parts that are not related to the present disclosure may be omitted or not illustrated. In all drawings, the same or corresponding components are denoted by the same reference symbols, and common descriptions may be omitted.

### First Example Embodiment

### Configuration Description

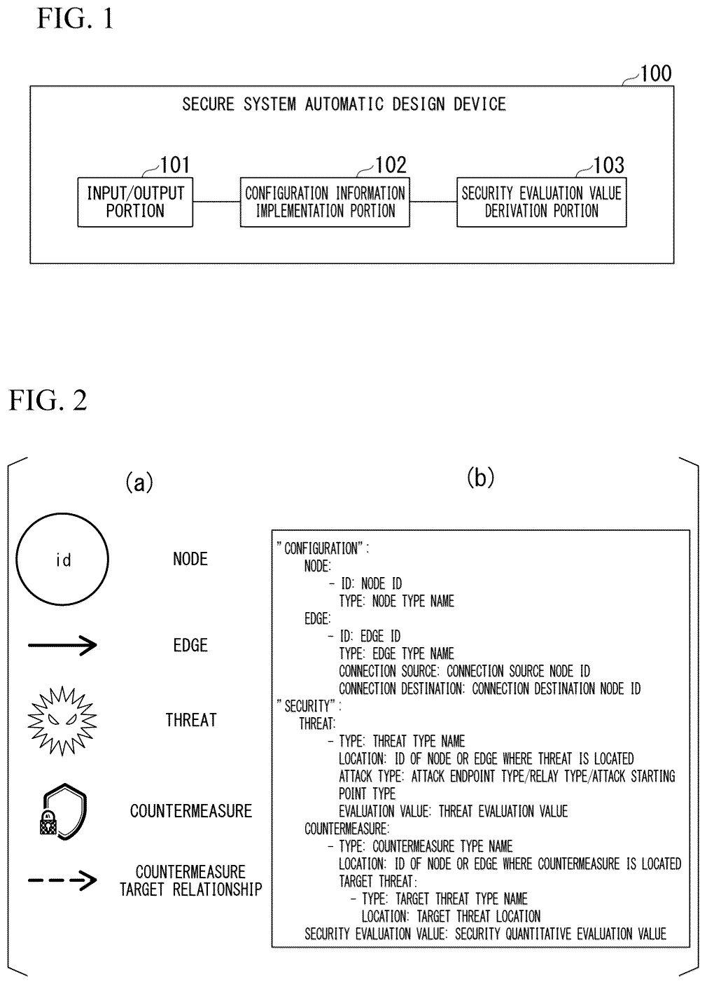

FIG. 1 is a schematic block diagram showing the functional configuration of a secure system automatic design device according to the first example embodiment. A secure system automatic design device 100 shown in FIG. 1 is provided with an input/output portion 101, a configuration information implementation portion 102, and a security evaluation value derivation portion 103.

The input/output portion 101 receives as input requirement data that is the subject of a secure system design, and transmits it to the configuration information implementation portion 102. Furthermore, the input/output portion 101 receives the system configuration plan whose concretization has been completed from the configuration information implementation portion 102, and outputs the system configuration plan as the design result of the secure system automatic design device 100.

The configuration information implementation portion 102 creates a search tree based on the requirement data received from the input/output portion 101, applies a “configuration implementation process” to the requirement data, and transmits it to the security evaluation value derivation portion 103 to derive a security evaluation value of the generated system configuration plan. Then, the system configuration plan that has been assigned a security evaluation value is received from the security evaluation value derivation portion 103, and if the system configuration plan is a concrete configuration, the system configuration plan is sent to the input/output portion 101 as a design result, and if the system configuration plan is not a concrete configuration, the system configuration plan is added to the search tree. Thereafter, a system configuration plan to which the configuration implementation process has not been applied is selected from the search tree, and the above process is repeated. If there are no system configuration plans in the search tree to which the configuration implementation process has not been applied, a design failure is output.

More specifically, in the “configuration implementation process,” the configuration information implementation portion 102 implements the abstract elements of the input requirement data and generates a search tree, which is a tree structure of the concretized system configuration plan, as disclosed in Non-Patent Document 1. The search tree is generated in the process of generating a concrete configuration from requirement data, and is expressed as a tree-structured graph with the requirement data as the root node. Leaf nodes represent implemented configuration plans for a system and include system configuration plans that are currently being designed. The system configuration plans that have advanced to the concrete stage are added to the search tree as lower-level leaf nodes. In other words, in the process of searching for a concrete configuration in the search tree, a configuration implementation process is applied to leaf nodes representing system configuration plans in the process of being implemented, and an implemented configuration plan in which abstract elements are partially implemented is generated as a leaf node representing the next state. In this process, the configuration information implementation portion 102 transmits the generated system configuration plan to the security evaluation value derivation portion 103 to determine whether or not it is secure. Then, the configuration information implementation portion 102 receives only the system configuration plan that has been determined to be “secure” by the security evaluation value derivation portion 103, and if the system configuration plan is a fully concretized configuration, it transmits the system configuration plan to the input/output portion 101 as the design result, and if the system configuration plan is not a concretized configuration, it adds the system configuration plan to the search tree. Thereafter, a system configuration plan to which the configuration implementation process has not been applied is selected from the search tree, and the above process is repeated. If there are no system configuration plans in the search tree to which the configuration implementation process has not been applied, a design failure is output.

The security evaluation value derivation portion 103 derives a security evaluation value for the system configuration plan received from the configuration information implementation portion 102, and updates the security information of the system configuration plan.

Next, data handled in the first example embodiment will be described.

FIG. 2 shows an example of an expression method used in an example of the system configuration plan according to the first example embodiment. A part (a) of FIG. 2 shows the legend for the pictorial representation, and a part (b) of FIG. 2 shows the legend for the textual representation. A system configuration plan is expressed by nodes that represent the components that make up the system and edges that represent the relationship between two components. In the pictorial representation of a system configuration plan, nodes are indicated by circles and edges are indicated by solid arrows, as shown in the part (a) of FIG. 2. An ID for identifying each individual node is written inside the circle representing the node. As shown in the part (a) of FIG. 2, a threat is represented graphically using a virus icon, and a countermeasure is represented using an icon of a padlock on a shield. As shown in the part (a) of FIG. 2, the target relationship of which countermeasures prevent or mitigate which threats is indicated by dashed arrows.

The textual representation of the system configuration plan is written in YAML format. In the example of the part (b) of FIG. 2, there are fields for describing information related to the configuration and security as information on the system configuration plan. The configuration information includes node and edge information, and the security information includes threats, countermeasures, and security evaluation value information. In the example of the part (b) of FIG. 2, the information for each node in the system configuration plan is given as its ID and type name; the information for each edge is given as its ID, type name, edge source node ID, and edge destination node ID; the information for a threat is given as its type name, location, and threat evaluation value; and the information for a countermeasure is given as the countermeasure type name, countermeasure location, target threat type name, and target threat location. The threat evaluation value in the threat column is provided by the security evaluation value derivation portion 103. In the present disclosure, the threat evaluation value is represented by a continuous quantitative value from 0.0 to 1.0. The target threat in the countermeasure column refers to the threat that the countermeasure is intended to prevent or mitigate. The security evaluation value column lists the security evaluation value of the entire system configuration plan calculated by the security evaluation value derivation portion 103. In the present disclosure, the security evaluation value is a quantitative value equal to or greater than 0.0, and the smaller the value, the more secure the configuration.

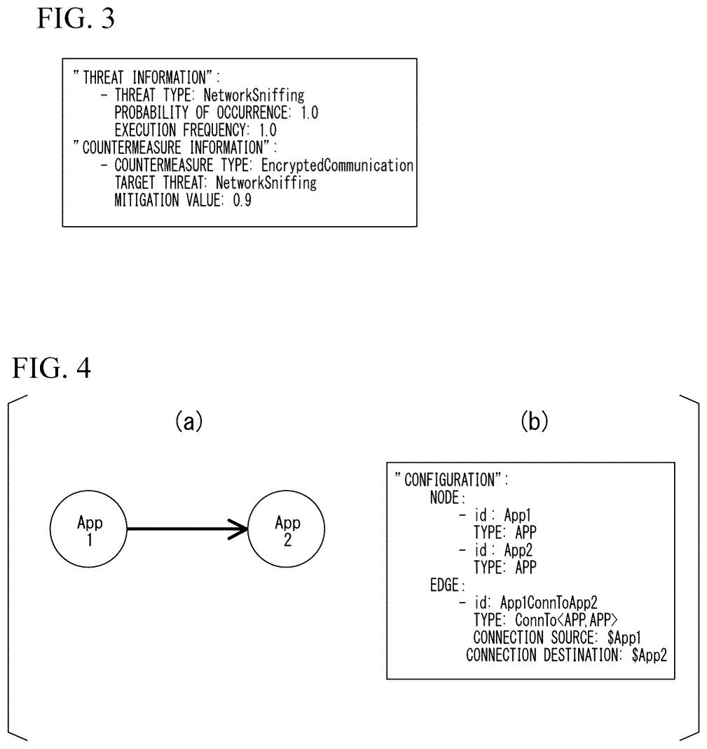

FIG. 3 shows an example of a security model used in the first example embodiment. The security model shown in FIG. 3 describes information about threats and countermeasures. In the example of FIG. 3, there are fields for describing threat information and countermeasure information. In the example of FIG. 3, the type name, probability of occurrence, and execution frequency are listed as threat information, while the type name, target threat, and mitigation value are listed as countermeasure information. Both the probability of a threat occurring and its execution frequency have continuous quantitative values ranging from 0.0 to 1.0. Countermeasure mitigation values have continuous quantitative values ranging from 0.0 to 1.0. These are all parameters used in a case where deriving a threat evaluation value. The security model is set in the security evaluation value derivation portion 103 by, for example, a user.

FIG. 4 shows an example of requirement data input to the secure system automatic design device in the first example embodiment. A part (a) of FIG. 4 is an example of the requirement data expressed graphically, and a part (b) of FIG. 4 is an example of the requirement data expressed textually. The requirement data shown in FIG. 4 shows a configuration in which there are two APP-type nodes, App1 and App2, which are connected by an edge of ConnTo<APP, APP> type.

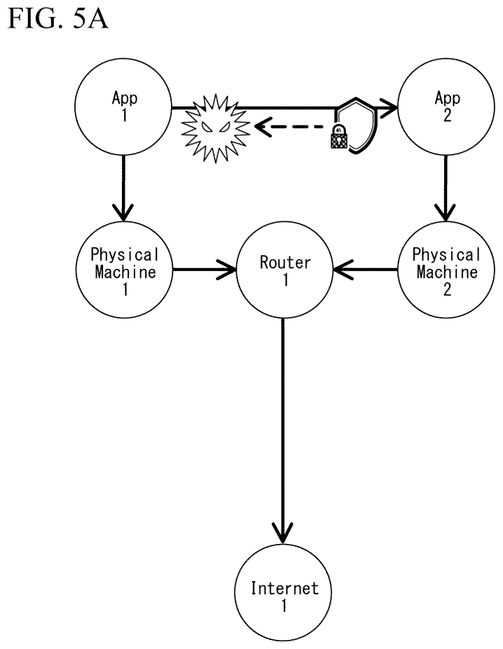

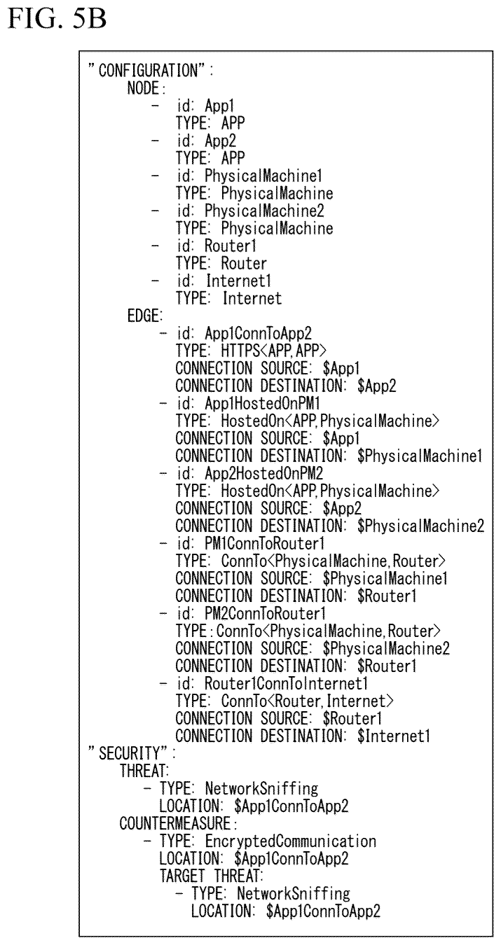

FIGS. 5A and 5B show examples of system configuration plans output by the configuration information implementation portion 102 and input to the security evaluation value derivation portion 103 in the first example embodiment. The information on security threats and countermeasures described in FIGS. 5A and 5B is given as system requirements (requirement data). Alternatively, for example, the configuration information implementation portion 102 may have a function for generating information on threats and countermeasures during the concretization process, and the information may be generated from the requirement data of the part (a) of FIG. 4 by the function. The generation of threat information is disclosed in example embodiment 2 of International Publication No. 2023/042257 (paragraph 0041 onwards). For example, a threat that corresponds to an attack endpoint attack threat may be defined as an “attack to be considered” at the input requirements stage, or may be defined in a threat model so as to be automatically generated in a case where specific components or relationships (nodes or edges) are present in the system configuration plan, and threat information may be generated by referring to this threat model. Alternatively, the configuration information implementation portion 102 may generate attack relay threats and attack launch point threats based on information on existing threats and their surrounding configurations in the system configuration plan, in accordance with information on “threat implementation rules” (not shown) that are defined separately. In addition, the generation of countermeasure information is disclosed in Japanese Patent Application No. 2023-098467, and is performed based on the “countermeasure information” described in the countermeasure model (FIG. 5B of Japanese Patent Application No. 2023-098467). For example, the “countermeasure information” includes at least the information on “countermeasure type,” “target threat,” and “countermeasure implementation condition configuration.” If a “target threat” exists in a certain system configuration plan and the surrounding area around the location of the threat satisfies the “countermeasure implementation condition configuration,” a countermeasure of the type specified in the “countermeasure type” is generated in a manner linked to the “target threat.” FIG. 5A is an example of a pictorial representation of a system configuration plan, and FIG. 5B is an example of a textual representation of the system configuration plan. In the examples of FIGS. 5A and 5B, in order for two APP type applications to communicate with each other, the two applications are each hosted on a PhysicalMachine-type physical machine, and the two physical machines are connected to a Router type router, which is connected to the Internet as shown by an Internet type node. In addition, it is shown that there are a NetworkSniffing-type eavesdropping threat and an EncryptedCommunication-type communication encryption countermeasure on the edge connecting App1 and App2, and that the countermeasures are intended to mitigate the threats in question.

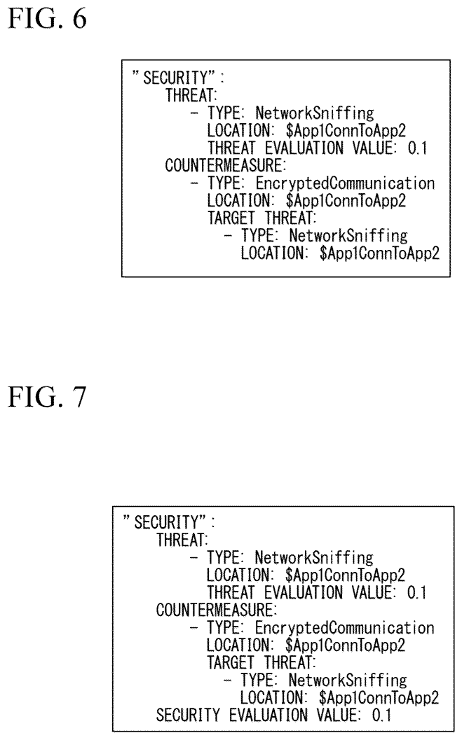

FIG. 6 shows an example of a system configuration plan resulting from performing the “threat evaluation value calculation process” in the security evaluation value derivation portion 103 on the system configuration plans shown in FIGS. 5A and 5B in the first example embodiment. In the example of the system configuration plan shown in FIG. 6, the description of the configuration fields is omitted since it is completely identical to the contents of FIG. 5B, and only the security fields are shown. The difference between the contents of FIG. 6 and FIG. 5B is that a column for threat evaluation values is added as information on NetworkSniffing-type threats. As shown in FIG. 6, the threat is given a threat evaluation value of 0.1. In the first example embodiment, as an example, the threat evaluation value is calculated by “probability of occurrence×execution frequency×mitigation rate” of the threat, but the method of calculating the threat evaluation value is not limited to this. For example, the threat evaluation value may be the sum of the three parameters. The “establishment probability” and “execution frequency” are calculated with reference to the numerical values described in the security model shown in FIG. 3. The “mitigation rate” is calculated as “1.0−the mitigation value of the countermeasure” for all countermeasures targeting the threat. The threat evaluation value is then the product of all these values multiplied together. In the examples shown in FIG. 6 and FIG. 3, the probability of occurrence and the execution frequency of the NetworkSniffing-type threat are both 1.0, as shown in FIG. 3. In addition, there is only one countermeasure that targets the NetworkSniffing-type threat, the EncryptedCommunication-type countermeasure, and the mitigation value of this countermeasure is 0.9 as shown in FIG. 3. Therefore, the mitigation rate of the threat is 0.1, which is “1.0−0.9”. In a case where the threat evaluation value is calculated based on these numerical values, it becomes “1.0×1.0×0.1=0.1”, so in the example shown in FIG. 6, the numerical value of 0.1 is entered in the threat evaluation value column for that threat.

FIG. 7 shows an example of a system configuration plan resulting from calculation of a security evaluation value by the security evaluation value derivation portion 103 for the system configuration plan shown in FIG. 6 in the first example embodiment. The difference between the system configuration plan in FIG. 7 and the system configuration plan in FIG. 6 is that a security evaluation value item has been added alongside the threats and countermeasures items in the security field, and a value of 0.1 has been assigned to this item. As an example of the present example embodiment, the security evaluation value is calculated as the sum of the threat evaluation values of all threats present in the system configuration plan, but the method of calculating the security evaluation value is not limited to this. For example, the security evaluation value may be calculated as a weighted sum of the threat evaluation values of all threats present in the system configuration plan, or as a product of all the threat evaluation values. In the example shown in FIG. 7, there is only one threat, that of NetworkSniffing type, and since the threat evaluation value of this threat is 0.1, the security evaluation value is also given a value of 0.1.

### Description of Operation

Next, the operation of the first example embodiment will be described.

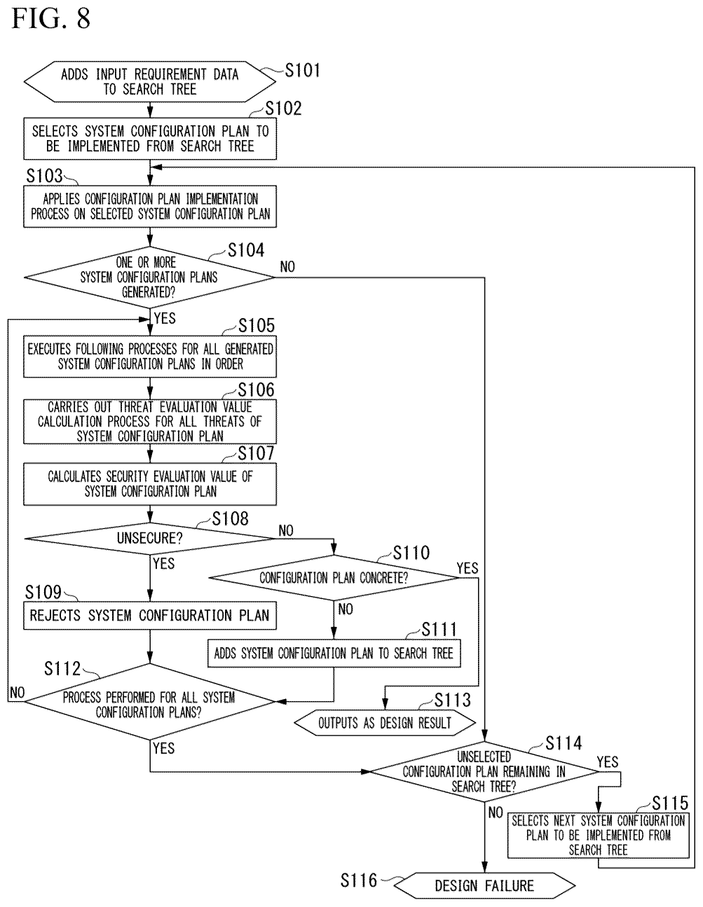

FIG. 8 is a flowchart showing an example of the operation of the secure system automatic design device according to the first example embodiment.

First, the input/output portion 101 receives input requirement data and adds it to the search tree (S101). Thereafter, the information of the search tree is transmitted to the configuration information implementation portion 102. Next, the configuration information implementation portion 102 selects one system configuration plan to be implemented from the search tree (S102). Once the target system configuration plan has been selected, a configuration plan implementation process is carried out on the system configuration plan (S103). As a result, it is determined whether one or more system configuration plans have been generated (S104), and if one or more implemented configuration plans have been generated (YES in S104), the process proceeds to S105, and if no system configuration plans have been generated (NO in S104), the process proceeds to the determination of S114.

In a case where one or more system configuration plans are generated in the configuration information implementation process (S103), all of the system configuration plans are sent to the security evaluation value derivation portion 103, and the security evaluation value derivation portion 103 executes the threat evaluation value calculation process and the security evaluation value calculation process for all of the system configuration plans in order (S105). First, a threat evaluation value calculation process is executed for the implemented configuration plan (S106). Thereafter, a security evaluation value calculation process is executed for the system configuration plan (S107). The threat evaluation value calculation process is as described with reference to FIG. 6. The security evaluation value calculation process is as described with reference to FIG. 7.

In a case where the calculation of the security evaluation value of the system configuration plan is completed, the security evaluation value derivation portion 103 determines whether the system configuration plan is unsecure or not, and transmits the result to the configuration information implementation portion 102 (S108). For example, if the security evaluation value of the system configuration plan to be evaluated is smaller than a predetermined threshold, the security evaluation value derivation portion 103 determines that the system configuration plan is “secure,” and if the security evaluation value is equal to or greater than the predetermined threshold, the security evaluation value derivation portion 103 determines that the system configuration plan is “unsecure.” If the determination result is “unsecure” (YES in S108), the system configuration plan is rejected (S109), and if the determination result is “secure” (NO in S108), an investigation is performed to see if the system configuration plan is a concrete configuration plan (S110). The term “concrete configuration plan” here refers to a configuration plan in which all of the components that make up the system are configured with concrete nodes and edges while satisfying all of the requirements indicated by the requirement data initially input to the input/output portion 101. If the system configuration plan is concrete (YES in S110), the system configuration plan is sent to the input/output portion 101 and output as the design result of the secure system automatic design device (S113). On the other hand, if the system configuration plan is not concrete (NO in S110), the system configuration plan is added to the search tree (S111).

After performing the processing of S109 or S111, the security evaluation value derivation portion 103 checks whether or not the series of processes from the threat evaluation value calculation process to the security determination have been performed for the entire system configuration plan generated in the configuration information implementation process (S112). If there is a system configuration plan to which the series of measures has not been applied (NO in S112), the process returns to S105 and the process is repeated. If there is no system configuration plan to which the series of processes is yet to be applied (YES in S112), the configuration information implementation portion 102 checks whether there is a system configuration plan remaining in the search tree that has not been selected as a target for the configuration implementation process (S114). If there are no unselected system configuration plans remaining in the search tree (NO in S114), it means that there is no way left within the secure system automatic design device to implement the requirement data while satisfying the security requirements, and the input/output portion 101 outputs a design failure (S116). If an unselected system configuration plan remains in the search tree (YES in S114), the next system configuration plan to be implemented is selected from the search tree (S115), and the process returns to S103 to repeat the configuration information implementation process. In the flowchart of FIG. 8, the implemented system configuration plan is determined to be “secure” or “unsecure” based on the security evaluation value. However, multiple system configuration plans that have been determined to be “secure” may be arranged in order of lowest security evaluation value, and the system configuration plan with the lower security evaluation value may be evaluated as “more secure.”

### Effect Description

As described above, according to the first example embodiment, a security evaluation value is calculated, and it is possible to determine whether a system is “secure” or “unsecure” based on the security evaluation value. In other words, it is possible to quantitatively determine whether a system configuration is secure or not. In addition, for system configuration plans that are evaluated as secure, it is possible to evaluate which system configuration plan is “more secure” by comparing the security evaluation values of each plan.

### Second Example Embodiment

### Configuration Description

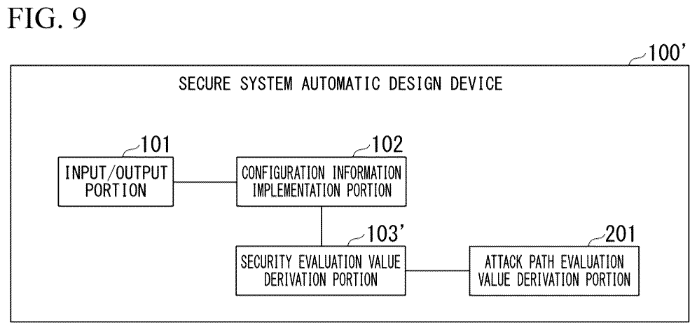

FIG. 9 is a schematic block diagram showing a functional configuration of a secure system automatic design device according to the second example embodiment. The secure system automatic design device 100′ shown in FIG. 9 includes the input/output portion 101, the configuration information implementation portion 102, a security evaluation value derivation portion 103′, and an attack path evaluation value derivation portion 201.

The input/output portion 101 and the configuration information implementation portion 102 have the same functions as those in the first example embodiment. The security evaluation value derivation portion 103′ derives a security evaluation value for the system configuration plan received from the configuration information implementation portion 102, and updates the security information of the system configuration plan. Thereafter, in order to derive an attack path evaluation value for the system configuration plan, the system configuration plan information is sent to the attack path evaluation value derivation portion 201. Then, the system configuration plan for which the attack path evaluation value has been derived is received from the attack path evaluation value derivation portion 201, and the system configuration plan is sent to the configuration information implementation portion 102.

The attack path evaluation value derivation portion 201 derives an attack path evaluation value of the system configuration plan based on the system configuration plan information received from the security evaluation value derivation portion 103′. Thereafter, the derived attack path evaluation value information is reflected in the system configuration plan, and the system configuration plan is then transmitted to the security evaluation value derivation portion 103′.

Next, data handled in the second example embodiment will be described.

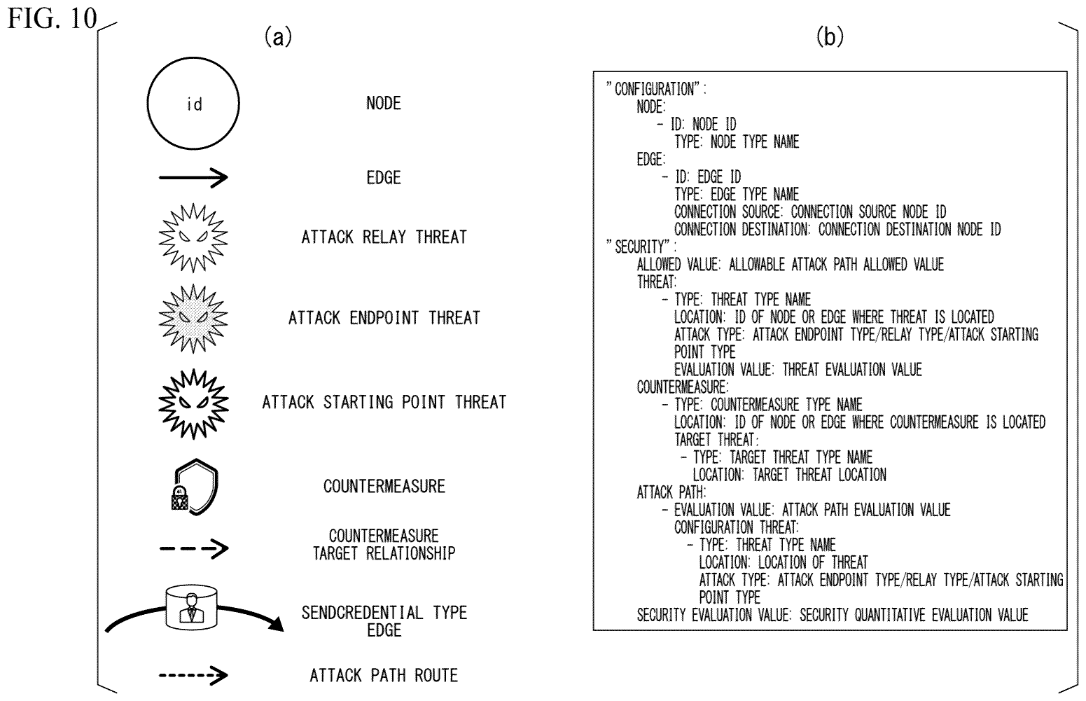

FIG. 10 shows an example of a method of expressing a system configuration plan according to the second example embodiment. A part (a) of FIG. 10 shows the legend for the pictorial representation, and a part (b) of FIG. 10 shows the legend for the textual representation. In the part (a) of FIG. 10, the nodes, edges, countermeasures, and countermeasure target relationships are as described in the part (a) of FIG. 2. In the second example embodiment, threats are classified into three types: “attack relay threats,” “attack endpoint threats,” and “attack starting point threats,” and different images are assigned to each type. An attack endpoint threat is a threat that indicates what an attacker who carries out a cyberattack ultimately wants to achieve, and is represented by a virus-type icon on a gray background, as shown in the part (a) of FIG. 10. An attack-based threat is a threat that indicates an attack that an attacker can carry out unconditionally, without depending on the existence of other threats, and is represented by a virus-type icon with a thick border, as shown in the part (a) of FIG. 10. An attack relay threat is a threat that does not belong to either the attack endpoint threat or the attack starting point threat, and is represented by a virus-type icon with a thin border as shown in the part (a) of FIG. 10. As shown in the part (a) of FIG. 10, the route of an “attack path” indicating the order in which an attacker executes threats to effect an attack is indicated by a dotted arrow. Furthermore, as shown in the part (a) of FIG. 10, among edges, edges of “SendCredential type” in particular are represented using a diagram in which a cylindrical icon and a person icon are placed on a curved arrow.

The part (b) of FIG. 10 shows an example of a legend for the textual representation of a system configuration plan written in the YAML format. The contents of this system configuration plan are basically the same as that shown in the part (b) of FIG. 2. The differences from the part (b) of FIG. 2 will be described below. As shown in the part (b) of FIG. 10, a column for “attack type” has been added to the threat field. The attack type column describes information on whether the threat is an attack endpoint type, a relay type, or a starting point type. As shown in the part (b) of FIG. 10, in the example of the system configuration plan handled in the second example embodiment, columns of “allowed value” and “attack path” are added to the security field. The allowed value is a real value ranging from 0.0 to 1.0 that is defined in the requirement data by the customer who uses the secure system automatic design device 100′. If the system configuration plan contains an attack path with an attack path evaluation value that exceeds the allowed value, the system configuration plan does not satisfy the requirements and is rejected. As shown in the part (b) of FIG. 10, the attack path column in the textual representation of the system configuration plan includes a field for describing the evaluation value of the attack path and a field for describing information about the threats that constitute the attack path (shown as “configuration threats”). In the evaluation value column, the attack path evaluation value derived by the attack path evaluation value derivation portion 201 is written.

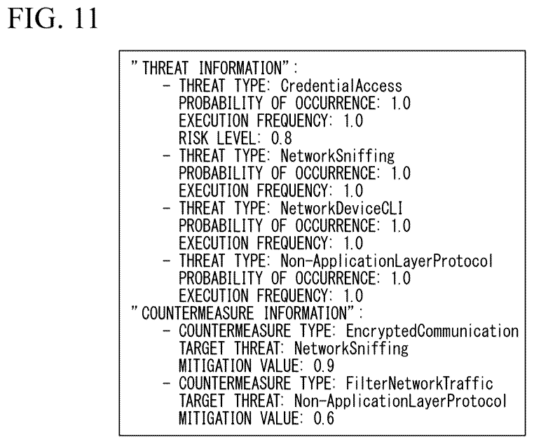

FIG. 11 shows an example of the security model used in the second example embodiment.

The format of the security model shown in FIG. 11 is basically the same as the format of the security model shown in FIG. 3, and the differences from FIG. 3 will be described below. In the security model shown in FIG. 11, a numerical value called “risk level” is defined as a parameter related to a CredentialAccess-type threat in addition to the probability of establishment and execution frequency. In the example of the present example embodiment, this risk level is a parameter used to derive an attack path evaluation value, and a numerical value is defined for threats that can become attack endpoint threats. The higher the numerical value of this risk level, the more dangerous the threat is. The security model is set in the security evaluation value derivation portion 103′ by, for example, a user.

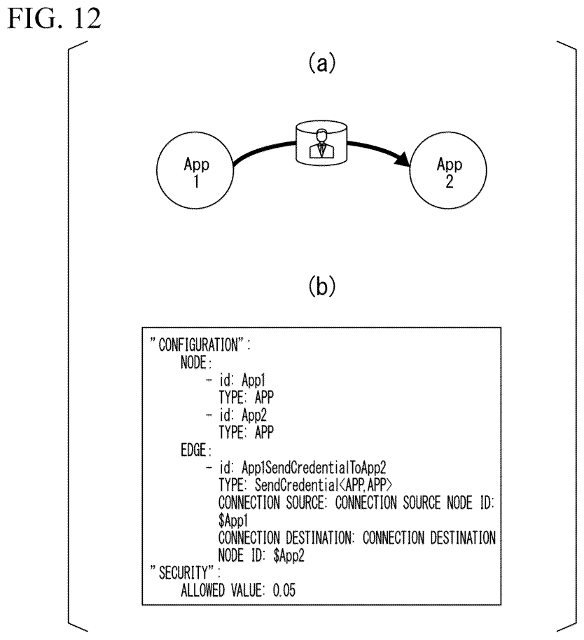

FIG. 12 shows an example of requirement data input to a secure system automatic design device 100′ in the second example embodiment. A part (a) of FIG. 12 is an example of the requirement data shown in a graphical representation, and a part (b) of FIG. 12 is an example of the requirement data shown in a textual representation. The requirement data shown in FIG. 12 shows a configuration in which there are two APP type nodes, App1 and App2, which are connected by an edge of SendCredential<APP, APP> type. Also, as shown in the part (b) of FIG. 12, in this example embodiment, the allowance is set to 0.05.

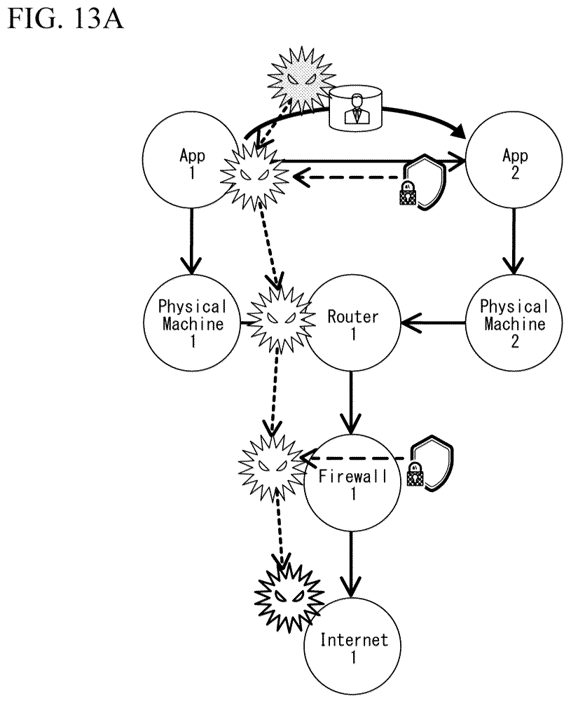

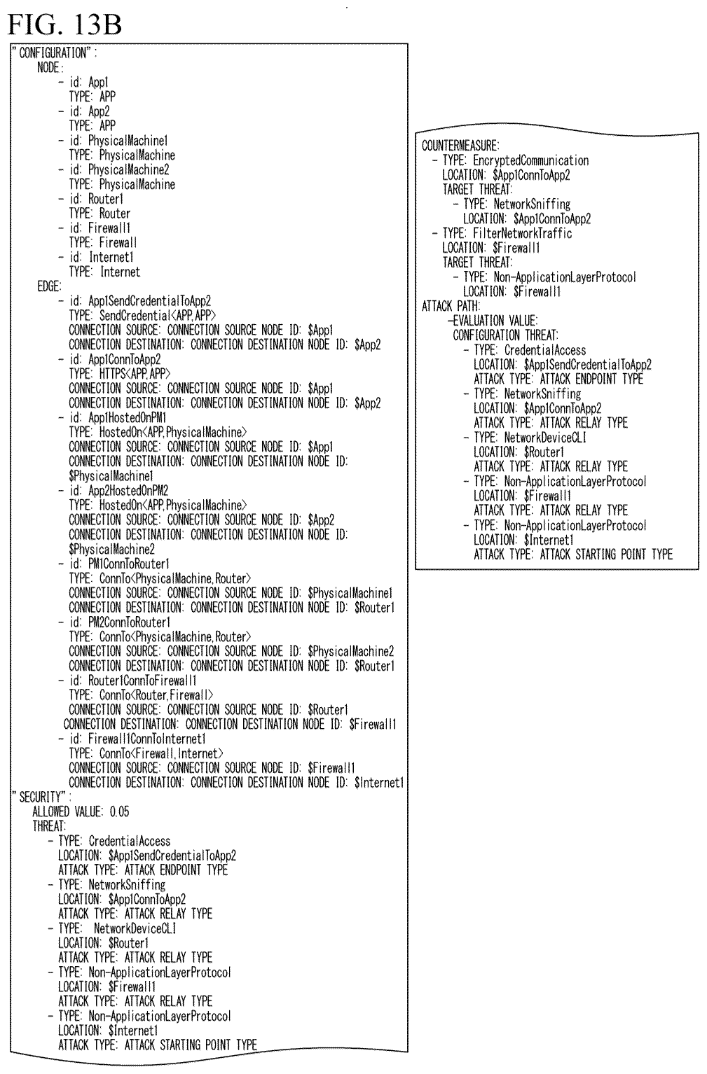

FIGS. 13A and 13B show examples of system configuration plans output by the configuration information implementation portion 102 and input to the security evaluation value derivation portion 103′ in the second example embodiment. FIG. 13A shows a pictorial representation of the system configuration plan, and FIG. 13B shows an example textual representation of the system configuration plan. The examples of FIGS. 13A and 13B show a configuration in which two APP type applications communicate to send and receive authentication information, the two applications are each hosted on a PhysicalMachine type physical machine, and the two physical machines are connected to a Router type router, which is connected to the Internet, represented by an Internet type node, via a firewall, represented by a Firewall type node. In addition, on the edge connecting App1 and App2, there are the CredentialAccess-type threat of authentication information harvesting, the NetworkSniffing-type threat of eavesdropping, and the EncryptedCommunication-type countermeasure for communication encryption, on the Router the NetworkDeviceCLI-type threat of arbitrary code execution, and on Firewall1 and Internet1 the Non-ApplicationLayerProtocol-type threat of sending attack commands. In addition, CredentialAccess-type threats are attack endpoint threats, while Non-ApplicationLayerProtocol-type threats that exist on Internet 1 are attack starting threats. Note that the method of generating attack paths described in FIGS. 13A and 13B is disclosed in Patent Application No. 2023-098467, and in the present specification, it is assumed that the security evaluation value derivation portion 103′ has the function of generating attack paths described in Patent Application No. 2023-098467, and so a detailed explanation of the method of generating attack paths will be omitted. For example, the security evaluation value derivation portion 103′ generates an attack path by arranging threats from an attack endpoint type threat to an attack starting point type threat in the form of a list, based on information on the system configuration plan. An attack path refers to a chain of threats illustrating the steps an attacker would take to execute an attack that system designers aim to prevent, and is a concrete representation of the possible ways in which a “threat” can be realized. The security evaluation value derivation portion 103′ generates the attack path information shown in FIG. 13A and FIG. 13B.

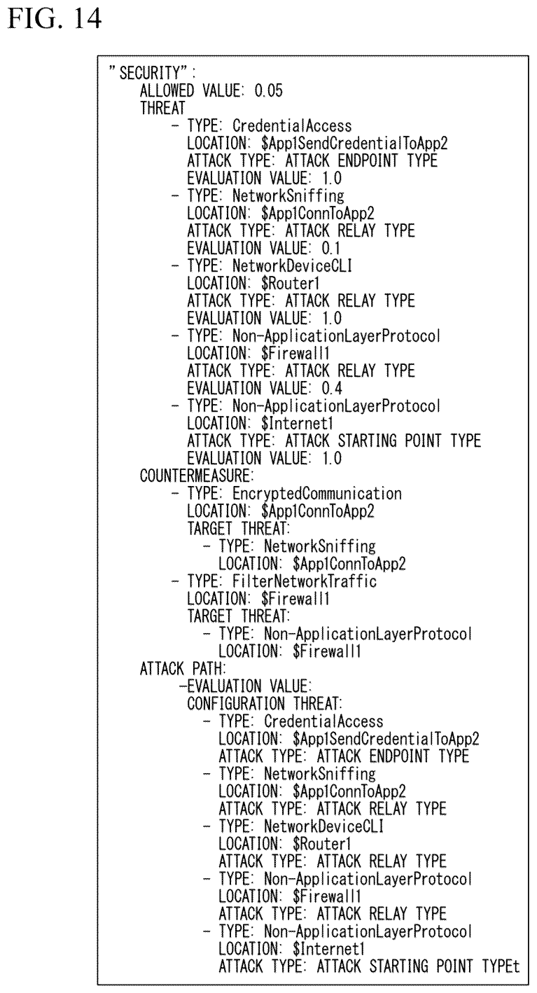

FIG. 14 shows an example of a system configuration plan resulting from performing the “threat evaluation value calculation process” in the security evaluation value derivation portion 103′ on the system configuration plan shown in FIG. 13 in the second example embodiment. In the example of the system configuration plan shown in FIG. 14, the description in the configuration field is omitted because it is completely identical to the content of FIG. 13B, and only the security field is described. The difference between the contents of FIG. 14 and FIG. 13B is that the system configuration plan in FIG. 14 adds a column for threat evaluation value (“evaluation value” in the figure) as information on the five threats that were present in the system configuration plan in FIG. 13B. Specifically, a threat evaluation value of 1.0 is given to the CredentialAccess type, a threat evaluation value of 0.1 is given to the NetworkSniffing type, a threat evaluation value of 1.0 is given to the NetworkDeviceCLI type, a threat evaluation value of 0.4 is given to the Non-ApplicationLayerProtocol type at location $Firewall1, and a threat evaluation value of 1.0 is given to the Non-ApplicationLayerProtocol type at location $Internet1. This process is as explained in the first example embodiment.

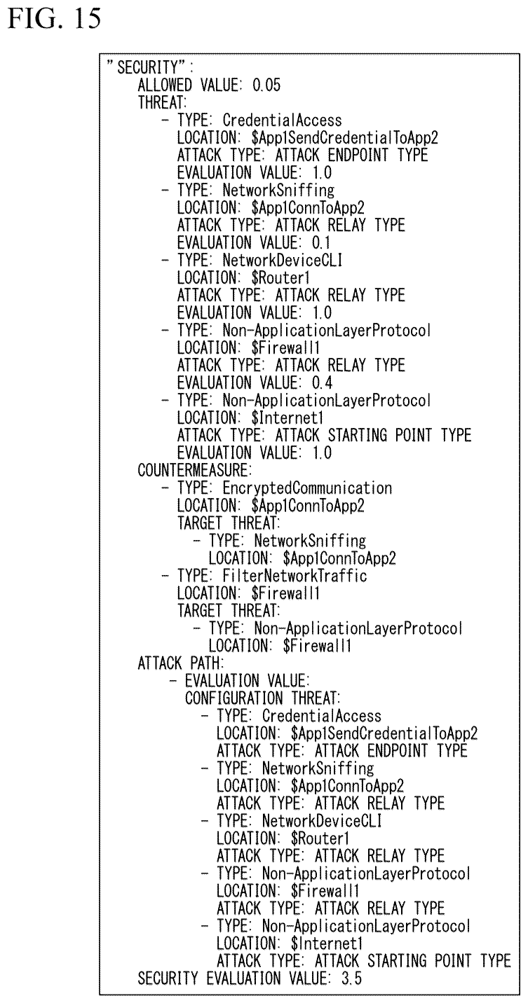

FIG. 15 shows an example of a system configuration plan obtained by calculating a security evaluation value in the security evaluation value derivation portion 103′ for the system configuration plan shown in FIG. 14 in the second example embodiment. The difference between the system configuration plan in FIG. 15 and the system configuration plan in FIG. 14 is that a security evaluation value item has been added alongside the threats and countermeasures items in the security field, and a value of 3.5 has been assigned to this item. As in the first example embodiment, in the second example embodiment as well, the security evaluation value is represented by the sum of the threat evaluation values of all threats present in the system configuration plan. The five threats present in the example system configuration plan shown in FIG. 15 have threat evaluation values of 1.0, 0.1, 1.0, 0.4, and 1.0, respectively, and the sum of these, 3.5, is given as the security evaluation value of the system configuration plan.

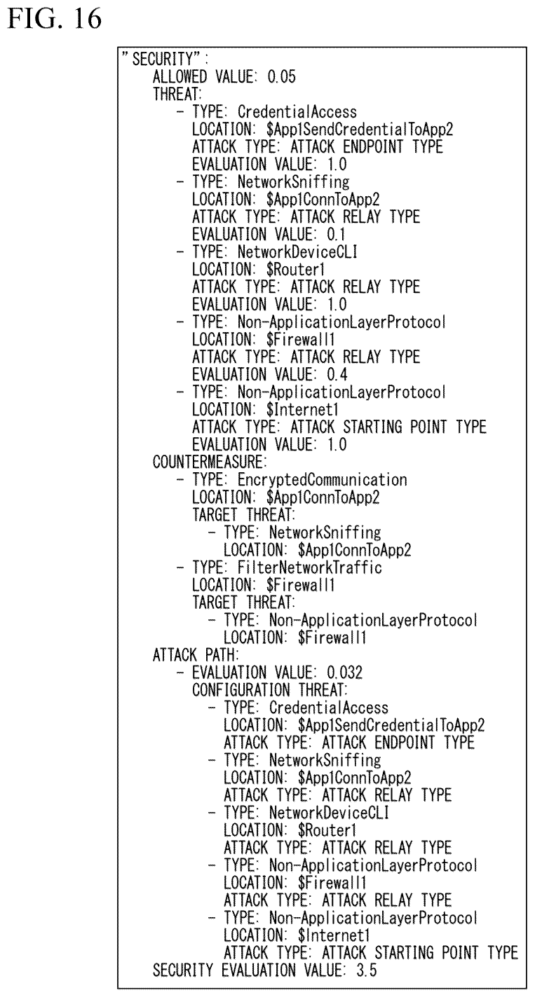

FIG. 16 shows an example of a system configuration plan obtained by deriving attack path evaluation values by the attack path evaluation value derivation portion 201 for the system configuration plan shown in FIG. 15 in the second example embodiment. The difference between the system configuration plan in FIG. 16 and the system configuration plan in FIG. 15 is that the value 0.032 is given to the column of the attack path evaluation value (attack path evaluation value) present in the attack path field. In the example of this example embodiment, the attack path evaluation value is defined as “the product of the threat evaluation values of all threats that make up the attack path×the risk level of the attack endpoint threat,” but the method of calculating the attack path evaluation value is not limited thereto. For example, the attack path evaluation value may be calculated as the sum of the threat evaluation values of all threats and the risk level of attack endpoint type threats. In the example shown in FIG. 16, the threat evaluation values of the five threats present in the system configuration plan are 1.0, 0.1, 1.0, 0.4, and 1.0, respectively, so the product of these is 0.04. As the risk level of the CredentialAccess threat, which is an attack endpoint threat, is 0.8 as described in FIG. 11, the attack path evaluation value is 0.032, which is obtained from “0.04×0.8=0.032”.

### Description of Operation

Next, the operation of the second example embodiment will be described.

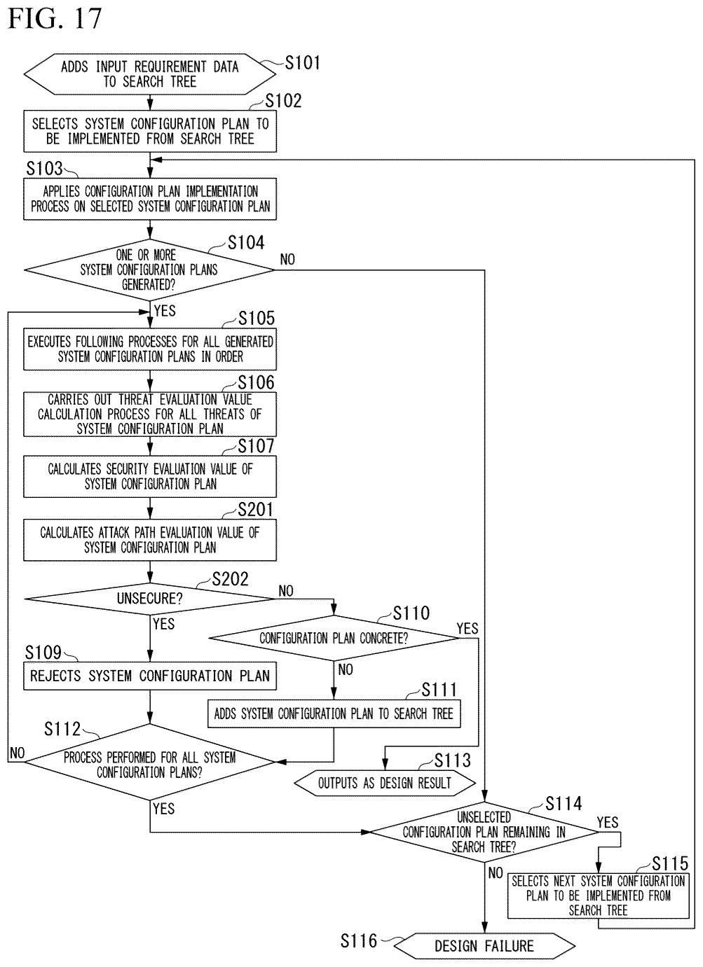

FIG. 17 is a flowchart showing the operation of the secure system automatic design device according to the second example embodiment.

First, the input/output portion 101 receives input requirement data and adds it to the search tree (S101). Thereafter, the information of the search tree is transmitted to the configuration information implementation portion 102. Next, the configuration information implementation portion 102 selects one system configuration plan to be implemented from the search tree (S102). Once the target system configuration plan has been selected, a configuration plan implementation process is carried out on the system configuration plan (S103). As a result, it is determined whether one or more system configuration plans have been generated (S104), and if one or more concrete configuration plans have been generated (YES in S104), the process proceeds to S105, and if no system configuration plans have been generated (NO in S104), the process proceeds to the determination of S114.

In a case where one or more system configuration plans are generated in the configuration information implementation process, all of the system configuration plans are sent to the security evaluation value derivation portion 103′, and the threat evaluation value calculation process, security evaluation value calculation process, and attack path evaluation value calculation process are executed for all of the system configuration plans in order (S105). First, a threat evaluation value calculation process is executed for the implemented configuration plan (S106). Thereafter, a security evaluation value calculation process is executed for the system configuration plan (S107). Subsequently, the security evaluation value derivation portion 103′ transmits the system configuration plan to the attack path evaluation value derivation portion 201. The attack path evaluation value derivation portion 201 executes an attack path evaluation value calculation process for the system configuration plan (S201). The attack path evaluation value derivation portion 201 transmits the system configuration plan in which the attack path evaluation value is set to the security evaluation value derivation portion 103′.

Once the calculation of the attack path evaluation value for the system configuration plan is completed, it is determined whether the system configuration plan is unsecure or not, and the result is sent to the configuration information implementation portion 102 (S202). In the example of the present example embodiment, whether a system configuration plan is unsecure or not is determined based on whether there is an attack path with an attack path evaluation value that exceeds the allowed value described in the system configuration plan. In the example of FIG. 16, the allowed value is 0.05, while the evaluation value of the only existing attack path is 0.032, which does not exceed the allowance, and therefore the system configuration plan is determined to be not unsecure.

If the determination result is “unsecure” (YES in S202), the system configuration plan is rejected (S109), and if the determination result is “secure” (NO in S202), an investigation is performed to see if the system configuration plan is a concrete configuration plan (S110). If the system configuration plan is concrete (YES in S110), the system configuration plan is sent to the input/output portion 101 and output as the design result of the secure system automatic design device 100′ (S113). On the other hand, if the system configuration plan is not concrete (NO in S110), the system configuration plan is added to the search tree (S111).

After the process of S109 or S111 is performed, it is checked whether or not the series of processes from the threat evaluation value calculation process to the security judgment process have been performed for all system configuration plans generated in the configuration information implementation process (S112). If there is a system configuration plan to which a series of measures has not been applied (NO in S112), the process returns to S105 and the process is repeated. If there is no system configuration plan to which a series of processes has not been applied (YES in S112), it is checked whether there is any system configuration plan remaining in the search tree that has not been selected as a target for the configuration implementation process (S114). If there are no unselected system configuration plans remaining in the search tree (NO in S114), it means that there is no way left within the secure system automatic design device 100′ to implement the requirement data while satisfying the security requirements, and the input/output portion 101 outputs a design failure (S116). If an unselected system configuration plan remains in the search tree (YES in S114), the next system configuration plan to be implemented is selected from the search tree (S115), and the process returns to S103 to repeat the configuration information implementation process. In the flowchart of FIG. 17, the implemented system configuration plan is determined to be “secure” or “unsecure” based on the attack path evaluation value. However, multiple system configuration plans that have been determined to be “secure” may be arranged in order of the smallest attack path evaluation value, and the system configuration plan with the smaller attack path evaluation value may be evaluated as “more secure.”

### Description of Effect

As described above, according to the second example embodiment, in addition to the security evaluation value, an attack path evaluation value is calculated, and a system configuration plan is determined to be “secure” or “unsecure” based on the attack path evaluation value, thereby enabling a quantitative evaluation. In addition, for system configuration plans evaluated as “secure”, it is possible to evaluate which system configuration plan is “more secure” by comparing the respective attack path evaluation values.

### Third Example Embodiment

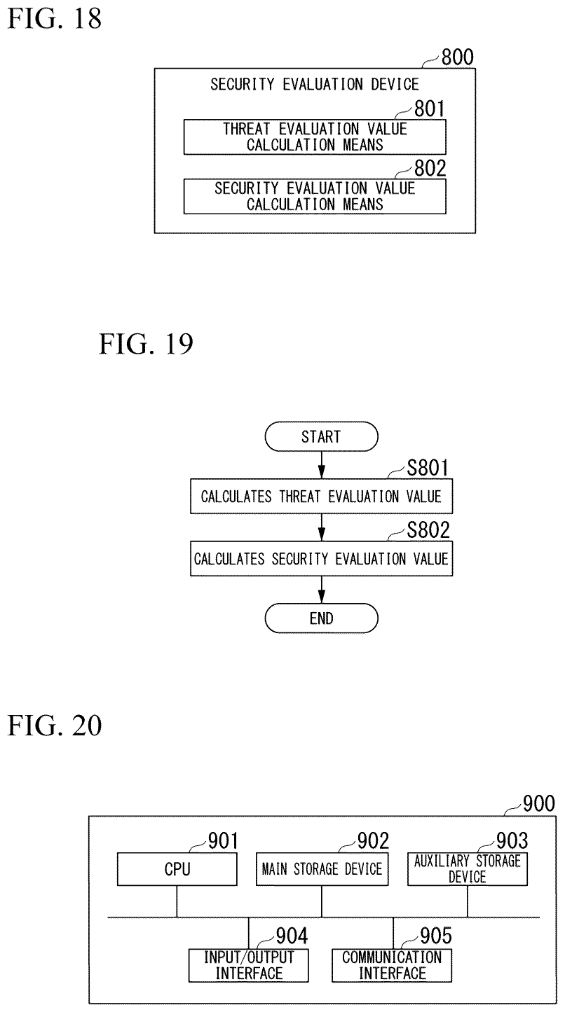

FIG. 18 is a schematic block diagram showing an example of a functional configuration of a security evaluation device.

The security evaluation device 800 comprises a threat evaluation value calculation means 801 which calculates a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are all defined for each type of security threat, and a security evaluation value calculation means 802 that calculates a quantitative security evaluation value for the system configuration plan based on the threat evaluation values calculated for each of all the threats. The security evaluation value and the attack path evaluation value of the example embodiment are examples of quantitative security evaluation values. The security evaluation value derivation portions 103 and 103′ are an example of the threat evaluation value calculation means 801. The security evaluation value derivation portions 103 and 103′ are an example of the security evaluation value calculation means 802.

FIG. 19 is a flowchart showing an example of the operation of the security evaluation device.

The threat evaluation value calculation means 801 calculates a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are all defined for each type of security threat (S801). The security evaluation value calculation means 802 calculates a quantitative security evaluation value for the system configuration plan based on the threat evaluation values calculated for all of the threats (S802).

FIG. 20 is a diagram illustrating an example of a hardware configuration of a secure system automatic design device. A computer 900 is provided with a CPU 901, a main storage device 902, an auxiliary storage device 903, an input/output interface 904, and a communication interface 905. The above-described secure system automatic design devices 100, 100′, and 800 are implemented in the computer 900. Each of the above-mentioned functions is stored in the auxiliary storage device 903 in the form of a program. The CPU 901 reads the program from the auxiliary storage device 903, loads it into the main storage device 902, and executes the above-mentioned processing in accordance with the program. Furthermore, the CPU 901 reserves a storage area in the main storage device 902 in accordance with the program. Furthermore, the CPU 901 reserves a storage area in the auxiliary storage device 903 for storing data being processed in accordance with the program.

In addition, a program for realizing all or some of the functions of the secure system automatic design devices 100, 100′, and 800 may be recorded on a computer-readable recording medium, and the program recorded on this recording medium may be read into a computer system and executed to perform processing by each functional unit. The term “computer system” here includes the OS and hardware such as peripheral devices. Furthermore, if the “computer system” utilizes a WWW system, it also includes the home page providing environment (or display environment). In addition, “computer-readable recording medium” refers to portable media such as CDs, DVDs, and USBs, as well as storage devices such as hard disks built into computer systems. Furthermore, in a case where this program is distributed to the computer 900 via a communication line, the computer 900 that receives the program may load the program into the main memory device 902 and execute the above-mentioned processing. Furthermore, the above program may be for realizing part of the functions described above, and may further be capable of realizing the functions described above in combination with a program already recorded in the computer system.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims. In addition, one example aspect of the present disclosure may be modified in various ways within the scope of the claims, and example embodiments obtained by appropriately combining the technical means disclosed in different example embodiments are also included in the technical scope of the present disclosure. Furthermore, the present disclosure also includes configurations in which elements described in the above example embodiments and modified examples are replaced with elements that produce similar effects. Moreover, each example embodiment can be appropriately combined with other example embodiments.

Some or all of the above-described example embodiments can be described as, but are not limited to, the following supplementary notes.

### Supplementary Note 1

A security evaluation device comprising: a means for calculating a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are defined for each type of security threat; and a means for calculating a quantitative security evaluation value for the system configuration plan based on the threat evaluation values calculated for each of all of the threats.

### Supplementary Note 2

The means for calculating the quantitative security evaluation value is the security evaluation device described in Supplementary Note 1, wherein the means for calculating a quantitative security evaluation value calculates the evaluation value by the weighted sum or sum of the threat evaluation values calculated for each of all the threats, or by the product of the threat evaluation values calculated for each of all the threats.

### Supplementary Note 3

The security evaluation device described in Supplementary Note 1 or Supplementary Note 2, wherein the means for calculating a quantitative security evaluation value calculates an attack path evaluation value, which is an evaluation value for a chain route of the threat in the system configuration plan, as the evaluation value, based on the threat evaluation value calculated for each of all of the threats and a predetermined risk level for an attack endpoint threat among all of the threats.

### Supplementary Note 4

The security evaluation device described in Supplementary Note (3), wherein the means for calculating a quantitative security evaluation value calculates the evaluation value by multiplying the threat evaluation value calculated for each of all the threats by the risk level.

### Supplementary Note 5

The security evaluation device described in any of (1) to (4), wherein the means for calculating a threat evaluation value calculates the threat evaluation value by multiplying an evaluation value of the probability of the threat occurring, an evaluation value of the execution frequency of the threat, and an evaluation value of the effectiveness of a mitigation measure against the threat.

### Supplementary Note 6

A security evaluation device comprising: a means for calculating a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are defined for each type of security threat; a means for calculating a security evaluation value that is a quantitative security evaluation value for the system configuration plan based on the threat evaluation values calculated for each of all of the threats; and a means for calculating an attack path evaluation value, which is an evaluation value for a chain route of the threat in the system configuration plan, as the evaluation value, based on the threat evaluation value calculated for each of all of the threats and a predetermined risk level for an attack endpoint threat among all of the threats.

### Supplementary Note 7

A secure system automatic design device comprising: a means for receiving design requirements for the system; a means for generating a plurality of system configuration plans that satisfy the design requirements; the security evaluation device according to any of supplementary notes (1) to (6), which calculates the evaluation value for each of the generated system configuration plans; and a means for determining whether each of the generated system configuration plans is secure or unsecure based on the security evaluation value.

### Supplementary Note 8

A security evaluation method calculating a threat evaluation value for each of all threats present in a system configuration plan based on an evaluation value of the probability of the threat occurring, an evaluation value of the execution frequency of the threat, and an evaluation value of the effectiveness of a mitigation measure for the threat that is possessed by a countermeasure against the threat, which are defined for each type of security threat; and calculating a quantitative security evaluation value for the system configuration plan based on the threat evaluation values calculated for each of all of the threats, the security evaluation being executed by a computer.

### Supplementary Note 9

A secure system automatic design method that receives system design requirements; generates a plurality of system configuration plans that satisfy the design requirements; calculates the evaluation value for each of the generated system configuration plans by the security evaluation method according to Supplementary Note (7); and determines whether each of the generated system configuration plans is secure or unsecure based on the evaluation value, the secure system automatic design method being executed by a computer.

### Supplementary Note 10

A program that causes a computer to execute the processing described in Supplementary Note 8.

### Supplementary Note 11

A program that causes a computer to execute the processing described in Supplementary Note 9.

What is claimed is:

1. A security evaluation device comprising:
at least one memory configured to store instructions; and
at least one processor configured to execute the instructions to:
calculate a threat evaluation value for each of all threats present in a system configuration plan based on an evaluation value of a probability of a threat occurring, an evaluation value of an execution frequency of the threat, and an evaluation value of an effectiveness of a mitigation measure for the threat that is possessed by a countermeasure against the threat, which are defined for each type of security threat; and
calculate a quantitative security evaluation value for the system configuration plan based on the threat evaluation values calculated for each of all of the threats.

2. The security evaluation device according to claim 1, wherein the at least one processor is configured to execute instructions to calculate the evaluation value by summing up the threat evaluation values calculated for all of the threats.

3. The security evaluation device according to claim 1, wherein the at least one processor is configured to execute instructions to calculate an attack path evaluation value, which is an evaluation value for a chain route of the threat in the system configuration plan, as the evaluation value, based on the threat evaluation value calculated for each of all of the threats and a predetermined risk level for an attack endpoint threat among all of the threats.

4. The security evaluation device according to claim 3, wherein the at least one processor is configured to execute instructions to calculate the evaluation value by multiplying the threat evaluation value calculated for each of all the threats by the risk level.

5. The security evaluation device according to claim 1, wherein the at least one processor is configured to execute instructions to calculate the threat evaluation value by multiplying the evaluation value of the probability of the threat occurring, the evaluation value of the execution frequency of the threat, and the evaluation value of the effectiveness of a mitigation measure for the threat.

6. A secure system automatic design device comprising:
the security evaluation device according to claim 1;
at least one second memory configured to store instructions; and
at least one second processor configured to execute the instructions to:
receive design requirements for the system; and
generate a plurality of system configuration plans that satisfy the design requirements; and
determine whether each of the generated system configuration plans is secure or unsecure based on the evaluation value,
wherein the at least one processor is configured to execute the instructions to calculate the evaluation value for each of the generated system configuration plans.

7. A security evaluation method executed by a computer, the method comprising:
calculating a threat evaluation value for each of all threats present in a system configuration plan based on an evaluation value of a probability of a threat occurring, an evaluation value of an execution frequency of the threat, and an evaluation value of an effectiveness of a mitigation measure for the threat that is possessed by a countermeasure against the threat, which are defined for each type of security threat; and
calculating a quantitative security evaluation value for the system configuration plan based on the threat evaluation values calculated for each of all of the threats.

8. A secure system automatic design method executed by a computer, the method comprising:
receiving system design requirements;
generating a plurality of system configuration plans that satisfy the design requirements;
calculating the evaluation value for each of the generated system configuration plans by the security evaluation method according to claim 7; and
determining whether each of the generated system configuration plans is secure or unsecure based on the evaluation value.

9. The security evaluation device according to claim 1, wherein the threats includes all of the threats in the system.
